(19) United States
(12) Patent Application Publication
(10) Pub. No.: US 2015/0244661 A1
(43) Pub. Date: Aug. 27, 2015

(54) METHOD AND APPARATUS FOR DISPLAYING RICH TEXT MESSAGE ON NETWORK PLATFORM, AND COMPUTER STORAGE MEDIUM

(71) Applicant: Tencent Technology (Shenzhen) Company Limited, Shenzhen (CN)

(72) Inventors: Jian ZHANG, Shenzhen (CN); Lei Chen, Shenzhen (CN); Tao Cao, Shenzhen (CN)

(21) Appl. No.: 14/709,381

(22) Filed: May 11, 2015

Related U.S. Application Data
(63) Continuation of application No. PCT/CN2013/085522, filed on Oct. 18, 2013.

(30) Foreign Application Priority Data
Nov. 14, 2012 (CN) 201210456926.2

(51) Int. Cl. H04L 12/58; G06F 17/21; G06F 3/0484

(52) U.S. Cl. CPC H04L 51/08; H04L 51/046; G06F 3/04842; G06F 17/218

(57) ABSTRACT

The present disclosure discloses a method performed by a computer server for processing a rich text message on a network platform, which includes: receiving a rich text message prepared by a third party at a first terminal, the rich text message comprising a structure of a rich text displaying manner; resolving the structure of the rich text displaying manner to generate a rich text in an HTML format, and causing the display of the rich text message including the rich text in the HTML format on a user interface at a second terminal; and extracting the structure of the rich text displaying manner after detecting a user selection of the rich text at the second terminal, so as to cause the display of the rich text at the second terminal. The present disclosure further discloses a computer server for performing the method, and an associated non-transitory computer readable storage medium.

### RELATED APPLICATIONS

This patent application is a continuation application of PCT Patent Application No. PCT/CN2013/085522, entitled “METHOD AND APPARATUS FOR DISPLAYING RICH TEXT MESSAGE ON NETWORK PLATFORM, AND COMPUTER STORAGE MEDIUM” filed on Oct. 18, 2013, which claims priority to Chinese Patent Application No. 201210456926.2, entitled “METHOD AND APPARATUS FOR DISPLAYING RICH TEXT MESSAGE ON NETWORK PLATFORM, AND COMPUTER STORAGE MEDIUM” filed on Nov. 14, 2012, both of which are incorporated by reference in their entirety.

### FIELD OF THE TECHNOLOGY

The present disclosure relates to Internet message publishing technologies, and in particular, to a method and an apparatus for processing a rich text message on a network platform, and a computer storage medium.

### BACKGROUND OF THE DISCLOSURE

A rich text message is a special message form, where a segment of rich text that can display more content is attached to a common text message.

When a rich text message is displayed on a current network platform, a segment of rich text in a hypertext markup language (HTML) format needs to be edited in advance for a subscribed third party, and then the rich text is attached to a bottom part of the displayed message. The rich text is magnified and displayed after a user clicks on the rich text.

### SUMMARY

Embodiments of the present disclosure mainly provide a method and an apparatus for processing a rich text message on a network platform, and a computer storage medium, which can display a rich text message provided by any third party, and enrich displayed content of the network platform.

The technical solutions of the embodiments of the present disclosure are implemented as follows:

A method for processing a rich text message on a network platform provided by an embodiment of the present disclosure includes:
receiving a rich text message prepared by a third party at a first terminal, the rich text message including a structure of a rich text displaying manner;
resolving the structure of the rich text displaying manner, so as to generate a rich text in an HTML format, and causing the display of the rich text message including the rich text in the HTML format on a user interface at a second terminal; and
extracting the structure of the rich text displaying manner by using an ID of the rich text message after detecting a user selection of the rich text at the second terminal, so as to cause the display of the rich text at the second terminal.

A computer server for processing a rich text message on a network platform provided by an embodiment of the present disclosure includes: one or more processors, memory, and a plurality of program modules stored in the memory and executed by the one or more processors, the plurality of program modules further including:
a rich text message receiving module configured to receive a rich text message prepared by a third party at a first terminal, the rich text message including a structure of a rich text displaying manner;
a message displaying module configured to resolve the structure of the rich text displaying manner in the rich text message received by the rich text message receiving module, so as to generate a rich text in an HTML format, and cause the display of the rich text message including the rich text in the HTML format on a user interface at a second terminal; and
a rich text displaying module configured to extract the structure of the rich text displaying manner by using an ID of the rich text message after detecting a user selection of the rich text at the second terminal, so as to cause the display of the rich text at the second terminal.

The present disclosure further provides a non-transitory computer readable storage medium storing one or more program modules for execution by one or more processors of a computer server and for executing the method for processing a rich text message on a network platform as described above.

The embodiments of the present disclosure provide a method and an apparatus for processing a rich text message on a network platform, and a non-transitory computer readable storage medium, where the method includes: receiving, by a server of the network platform, a rich text message prepared by a third party at a first terminal, the rich text message including a structure of a rich text displaying manner; resolving the structure of the rich text displaying manner, so as to generate a rich text in an HTML format, and causing the display of the rich text message including the rich text in the HTML format on a user interface at a second terminal; and extracting, by the server of the network platform, the structure of the rich text displaying manner in the rich text message by using an ID of the rich text message after detecting a user selection of the rich text at the second terminal, so as to cause the display of the rich text at the second terminal according to the structure. In this way, a rich text message provided by any third party can be displayed, and displayed content of the network platform can be enriched.

### BRIEF DESCRIPTION OF THE DRAWINGS

FIG. 1 is a schematic flowchart of a method for processing a rich text message on a network platform according to an embodiment of the present disclosure; and

FIG. 2 is a schematic structural diagram of an apparatus for processing a rich text message on a network platform according to an embodiment of the present disclosure.

### DESCRIPTION OF EMBODIMENTS

In embodiments of the present disclosure, a server of a network platform receives a rich text message prepared by a third party at a first terminal, the rich text message including a structure of a rich text displaying manner; the structure of the rich text displaying manner is resolved, so as to generate a rich text in an HTML format, and the rich text message including the rich text in the HTML format is displayed on a user interface; and the structure of the rich text displaying manner in the rich text message is extracted by using an ID of the rich text message after detecting a user selection of the rich text at the second terminal, so as to cause the display of the rich text at the second terminal according to the structure.

The network platform generally may be a microblog, a forum, a social network site, or the like.

The following further describes the present disclosure in detail with reference to the accompanying drawings and specific embodiments.

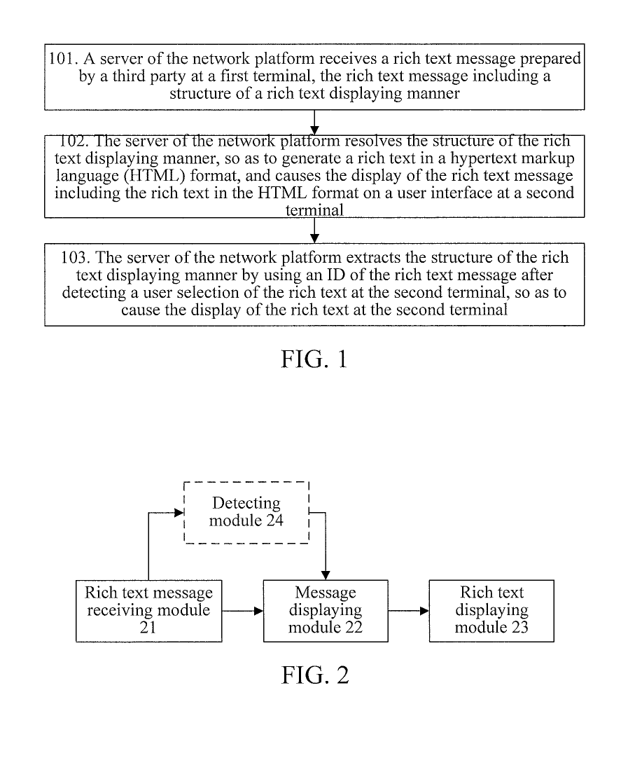

An embodiment of the present disclosure provides a method for processing a rich text message on a network platform. As shown in FIG. 1, the method includes the following steps:

Step 101: A server of the network platform receives a rich text message prepared by a third party at a first terminal, the rich text message including a structure of a rich text displaying manner. The server is connected to the first terminal via a computer network.

The rich text message edited by the third party is sent to the server of the network platform through an API port.

The third party is a user who subscribes in advance to use a rich text technology.

The rich text displaying manner includes: an iframe manner or a Flash manner.

A structure of the iframe manner includes: a Type field, a Pic field, a Name field, a Description field and a Uniform resource locator (URL) field, where the Type field is added with third party identifiers, used for distinguishing different third parties; the Pic field is added with a picture when the rich text is unfolded; the Name field is added with a name of the rich text message; the Description field is added with description of the rich text message; and the URL field is added with an iframe address.

A structure of the Flash manner includes: a Type field, a Pic field, a Name field, a Description field and a URL field, where the Type field is added with third party types, used for distinguishing different third parties; the Pic filed is added with a picture when the rich text is unfolded; the Name field is added with a name of the rich text message; the Description field is added with description of the rich text message; and the URL field is added with a Flash address.

The Type field, the Pic field, the Name field, the Description field and the URL field are added by the third party.

A format of the structure of the rich text displaying manner in the rich text message is a Type Length Value (TLV) field format.

Step 102: Resolve, by the server of the network platform, the structure of the rich text displaying manner, so as to generate a rich text in an HTML format, and cause the display of the rich text message including the rich text in the HTML format on a user interface at a second terminal. The server is connected to the second terminal via a computer network.

The rich text in the HTML format is attached to a bottom part of a message body of the rich text message.

The rich text in the HTML format contains static information.

The static information includes content of the Pic field, the Name field, and the Description field.

Step 103: Extract, by the server of the network platform, the structure of the rich text displaying manner in the rich text message by using an ID of the rich text message after detecting a user selection of the rich text at the second terminal, so as to cause the display of the rich text at the second terminal according to the structure.

The ID of the rich text message is an ID allocated to the rich text message by the server of the network platform, which belongs to the existing technology.

In the above method, whether URL field content of the structure of the rich text displaying manner in the rich text message breaches a regulation is detected by using a breach signature database after the server of the network platform receives the rich text message edited by the third party through the API port; the rich text message including the rich text is displayed on the user interface when the URL field content does not breach the regulation; and the rich text in the rich text message is not displayed on the user interface when the URL field content breaches the regulation.

Whether the URL field content of the structure of the rich text displaying manner in the rich text message breaches a regulation is detected by using a breach signature database is: detecting whether a feature in the breach signature database is matched with the URL field content of the structure of the rich text displaying manner in the rich text message; when the feature is matched with the URL field content, it is determined that the URL field content breaches the regulation; and otherwise, it is determined that the URL field content does not breach the regulation.

The breach signature database is established on a server side of the network platform in advance, and stores at least one feature.

To implement the above method, an embodiment of the present disclosure further provides an apparatus for processing a rich text message on a network platform, and the apparatus is located at a server side of the network platform and includes one or more processors, memory and a plurality of program modules. As shown in FIG. 2, the plurality of program modules include: a rich text message receiving module 21, a message displaying module 22, and a rich text displaying module 23.

The rich text message receiving module 21 is configured to receive a rich text message prepared by a third party at a first terminal, the rich text message including a structure of a rich text displaying manner.

The message displaying module 22 is configured to resolve the structure of the rich text displaying manner in the rich text message received by the rich text message receiving module 21, so as to generate a rich text in an HTML format, and cause the display of the rich text message including the rich text in the HTML format on a user interface at a second terminal.

The rich text displaying module 23 is configured to extract the structure of the rich text displaying manner in the rich text message by using an ID of the rich text message after detecting a user selection of the rich text at the second terminal, so as to cause the display of the rich text at the second terminal according to the structure.

The rich text message edited by the third party is sent to the server of the network platform through an API port.

The third party is a user who subscribes in advance to use a rich text technology.

The rich text displaying manner includes: an iframe manner or a Flash manner.

A structure of the iframe manner includes: a Type field, a Pic field, a Name field, a Description field and a URL field, where the Type field is added with third party identifiers, used for distinguishing different third parties; the Pic field is added with a picture when the rich text is unfolded; the Name field is added with a name of the rich text message; the Description field is added with description of the rich text message; and the URL field is added with an iframe address.

A structure of the Flash manner includes: a Type field, a Pic field, a Name field, a Description field and a URL field, where the Type field is added with third party types, used for distinguishing different third parties; the Pic filed is added with a picture when the rich text is unfolded; the Name field is added with a name of the rich text message; the Description field is added with description of the rich text message; and the URL field is added with a Flash address.

The Type field, the Pic field, the Name field, the Description field and the URL field are added by the third party.

A format of the structure of the rich text displaying manner in the rich text message is a TLV field format.

The rich text in the HTML format is attached to a bottom part of a message body of the rich text message; the rich text in the HTML format contains static information; and the static information includes content of the Pic field, the Name field, and the Description field.

The plurality of program modules further include: an detecting module 24, configured to: detect whether URL field content of the structure of the rich text displaying manner in the rich text message breaches a regulation by using a breach signature database; send a notification of causing the display of the rich text message including the rich text on the user interface at the second terminal to the message displaying module 22 when the URL field content does not breach the regulation; and send a notification of not displaying the rich text in the rich text message on the user interface to the message displaying module 22 when the URL field content breaches the regulation.

When the method for processing a rich text message on a network platform according to the embodiment of the present disclosure is implemented in a form of software function module and sold or used as an independent product, the method may also be stored in a non-transitory computer readable storage medium. A person skilled in the art should understand that the embodiments of the present disclosure may be provided as a method, a system or a computer program product. Therefore, the present disclosure may use a form of a hardware embodiment, a software embodiment, or an embodiment combining software and hardware. In addition, this present disclosure may use a form of a computer program product implemented on one or more computer available storage media including computer available program code, The storage media include but are not limited to a USB flash drive, a removable hard disk, a read-only memory (ROM), a random access memory (RAM), a disk memory, a CD-ROM, an optical memory, and the like.

The present disclosure is described with reference to flowcharts and/or block diagrams of the method, the device (system), and the computer program product in the embodiments of the present disclosure. It should be understood that computer program instructions can implement each process and/or block in the flowcharts and/or block diagrams and a combination of processes and/or blocks in the flowcharts and/or block diagrams. These computer program instructions may be provided to a general-purpose computer, a dedicated computer, an embedded processor, or a processor of another programmable data processing device to generate a machine, so that an apparatus configured to implement functions specified in one or more processes in the flowcharts and/or one or more blocks in the block diagrams is generated by using instructions executed by the general-purpose computer or the processor of another programmable data processing device.

These computer program instructions may also be stored in a computer readable memory that can guide a computer or another programmable data processing device to work in a specific manner, so that the instructions stored in the computer readable memory generate a product including an instruction apparatus, where the instruction apparatus implements functions specified in one or more processes in the flowcharts and/or one or more blocks in the block diagrams.

These computer program instructions may also be loaded into a computer or another programmable data processing device, so that a series of operation steps are performed on the computer or another programmable data processing device to generate processing implemented by a computer, and instructions executed on the computer or another programmable data processing device provide steps for implementing functions specified in one or more processes in the flowcharts and/or one or more blocks in the block diagrams.

Although the preferred embodiments of the present disclosure are described, additional alterations and modifications can be made to the embodiments once a person skilled in the art conceives of the basic creative concepts. Therefore, the accompanying claims are intended to be described as including the preferred embodiments and all the alterations and modifications falling within the scope of the present disclosure.

Accordingly, an embodiment of the present disclosure further provides a computer storage medium, a computer program being stored in the computer storage medium, and the computer program being used for executing the method for processing a rich text message on a network platform according to the embodiments of the present disclosure.

The foregoing descriptions are merely preferred embodiments of the present disclosure, but are not intended to limit the protection scope of the present disclosure.

What is claimed is:

1. A method for processing a rich text message on a network platform, comprising:
at a computer having one or more processors and memory for storing programs to be executed by the one or more processors:
receiving a rich text message prepared by a third party at a first terminal, the rich text message comprising a structure of a rich text displaying manner;
resolving the structure of the rich text displaying manner, so as to generate a rich text in a hypertext markup language (HTML) format, and causing the display of the rich text message including the rich text in the HTML format on a user interface at a second terminal; and
extracting the structure of the rich text displaying manner by using an ID of the rich text message after detecting a user selection of the rich text at the second terminal, so as to cause the display of the rich text at the second terminal.

2. The method according to claim 1, further comprising:
receiving the rich text message from the third party through an API port.

3. The method according to claim 1, wherein the rich text displaying manner comprises: an iframe manner or a Flash manner.

4. The method according to claim 3, wherein a structure of the iframe manner comprises: a Type field, a Pic field, a Name field, a Description field and a Uniform resource locator (URL) field, wherein the Type field is added with third party identifiers, used for distinguishing different third parties; the Pic field is added with a picture when the rich text is unfolded; the Name field is added with a name of the rich text message; the Description field is added with description of the rich text message; and the URL field is added with an iframe address; and
a structure of the Flash manner comprises: a Type field, a Pic field, a Name field, a Description field and a URL field, wherein the Type field is added with third party types, used for distinguishing different third parties; the Pic filed is added with a picture when the rich text is unfolded; the Name field is added with a name of the rich text message; the Description field is added with description of the rich text message; and the URL field is added with a Flash address.

5. The method according to claim 1, wherein a format of the structure of the rich text displaying manner is a Type Length Value (TLV) field format.

6. The method according to claim 1, further comprising:
after receiving the rich text message from the third party, detecting whether URL field content of the structure of the rich text displaying manner in the rich text message breaches a regulation by using a breach signature database; and
causing the display of the rich text message including the rich text on the user interface at the second terminal when the URL field content does not breach the regulation.

7. A computer server for processing a rich text message on a network platform, comprising:
one or more processors;
memory; and
a plurality of program modules stored in the memory and executed by the one or more processors, the plurality of program modules further including:
a rich text message receiving module configured to receive a rich text message prepared by a third party at a first terminal, the rich text message comprising a structure of a rich text displaying manner;
a message displaying module configured to resolve the structure of the rich text displaying manner in the rich text message received by the rich text message receiving module, so as to generate a rich text in an HTML format, and cause the display of the rich text message including the rich text in the HTML format on a user interface at a second terminal; and
a rich text displaying module configured to extract the structure of the rich text displaying manner by using an ID of the rich text message after detecting a user selection of the rich text at the second terminal, so as to cause the display of the rich text at the second terminal.

8. The computer server according to claim 7, wherein the rich text message from the third party is received through an API port.

9. The computer server according to claim 7, wherein the rich text displaying manner comprises: an iframe manner or a Flash manner.

10. The computer server according to claim 9, wherein a structure of the iframe manner comprises: a Type field, a Pic field, a Name field, a Description field and a URL field, wherein the Type field is added with third party identifiers, used for distinguishing different third parties; the Pic field is added with a picture when the rich text is unfolded; the Name field is added with a name of the rich text message; the Description field is added with description of the rich text message; and the URL field is added with an iframe address; and
a structure of the Flash manner comprises: a Type field, a Pic field, a Name field, a Description field and a URL field, wherein the Type field is added with third party types, used for distinguishing different third parties; the Pic filed is added with a picture when the rich text is unfolded; the Name field is added with a name of the rich text message; the Description field is added with description of the rich text message; and the URL field is added with a Flash address.

11. The computer server according to claim 7, wherein the plurality of program modules further include:
an detecting module, configured to detect whether URL field content of the structure of the rich text displaying manner in the rich text message breaches a regulation by using a breach signature database, and send a notification of causing the display of the rich text message including the rich text on the user interface at the second terminal to the message displaying module when URL field content does not breach the regulation.

12. The computer server according to claim 7, wherein a format of the structure of the rich text displaying manner is a Type Length Value (TLV) field format.

13. A non-transitory computer readable storage medium storing one or more program modules for execution by one or more processors of a computer server, the one or more program modules including instructions for:
receiving a rich text message prepared by a third party at a first terminal, the rich text message comprising a structure of a rich text displaying manner;
resolving the structure of the rich text displaying manner, so as to generate a rich text in a hypertext markup language (HTML) format, and causing the display of the rich text message including the rich text in the HTML format on a user interface at a second terminal; and
extracting the structure of the rich text displaying manner by using an ID of the rich text message after detecting a user selection of the rich text at the second terminal, so as to cause the display of the rich text at the second terminal.

14. The non-transitory computer readable storage medium according to claim 13, wherein the one or more program modules further include instructions for:
receiving the rich text message from the third party through an API port.

15. The non-transitory computer readable storage medium according to claim 13, wherein the rich text displaying manner comprises: an iframe manner or a Flash manner.

16. The non-transitory computer readable storage medium according to claim 15, wherein a structure of the iframe manner comprises: a Type field, a Pic field, a Name field, a Description field and a Uniform resource locator (URL) field, wherein the Type field is added with third party identifiers, used for distinguishing different third parties; the Pic field is added with a picture when the rich text is unfolded; the Name field is added with a name of the rich text message; the Description field is added with description of the rich text message; and the URL field is added with an iframe address; and
a structure of the Flash manner comprises: a Type field, a Pic field, a Name field, a Description field and a URL field, wherein the Type field is added with third party types, used for distinguishing different third parties; the Pic filed is added with a picture when the rich text is unfolded; the Name field is added with a name of the rich text message; the Description field is added with description of the rich text message; and the URL field is added with a Flash address.

17. The non-transitory computer readable storage medium according to claim 13, wherein a format of the structure of the rich text displaying manner is a Type Length Value (TLV) field format.

18. The non-transitory computer readable storage medium according to claim 13, wherein the one or more program modules further include instructions for:
after receiving the rich text message from the third party, detecting whether URL field content of the structure of the rich text displaying manner in the rich text message breaches a regulation by using a breach signature database; and
causing the display of the rich text message including the rich text on the user interface at the second terminal when the URL field content does not breach the regulation.
